(19) United States
(12) Patent Application Publication
(10) Pub. No.: US 2026/0285201 A1
(43) Pub. Date: Sep. 24, 2026

(54) SWIVEL ACTUATOR

(71) Applicant: AMOTECH CO., LTD., Incheon (KR)

(72) Inventor: Byung Soo KIM, Incheon (KR)

(21) Appl. No.: 18/873,649

(22) PCT Filed: Jun. 7, 2023
(86) PCT No.: PCT/KR2023/007756

§ 371 Date: Dec. 10, 2024

(30) Foreign Application Priority Data
Jun. 30, 2022 (KR) 10-2022-0080738
Jan. 5, 2023 (KR) 10-2023-0001844

(51) Int. Cl. B60N 2/02; F16H 1/16; H02K 7/116

(52) U.S. Cl. CPC B60N 2/02253; F16H 1/16; H02K 7/1166

(57) ABSTRACT

Provided is a swivel actuator capable of increasing fracture strength by increasing brake torque while minimizing backlash. The swivel actuator includes: a driving motor having a rotor worm gear integrally formed on the outer periphery of a cylindrical rotor support; first and second gear trains, each being arranged at 180 degree intervals at the outer periphery of the rotor worm gear and being coupled thereto, having, in the middle of first and second power transmission shafts, first and second worm wheels gear-coupled to the rotor worm gear, and having first to fourth worm gears formed at both sides of each of the first and second power transmission shafts; first to fourth pinion gear units, each having, at the lower ends thereof, third to sixth worm wheels gear-coupled to the first to fourth worm gears, and having first to fourth pinion gears integrally formed at the upper ends thereof; and a rotary table gear-coupled to a ring gear having the first to fourth pinion gears integrally formed on the inner side of the side surface portion thereof, so as to rotate.

### TECHNICAL FIELD

The present invention relates to a swivel actuator, and more particularly, to a swivel actuator capable of increasing fracture strength by increasing brake torque while minimizing backlash by adopting a double worm structure at both ends of each of first and second gear trains.

### BACKGROUND ART

An electric actuator rotates or linearly moves a table (or a passive object) to be driven with a high torque rotational force obtained by torque conversion of the rotational force generated from a rotating power source.

In general, the actuator has a low height of the housing as a whole product in use, and one of the horizontal and the vertical is configured to have a long shape. Accordingly, it is difficult to employ a structure in which a DC motor having an outer casing is vertically mounted on the inner bottom of the housing.

In the case of using a DC motor, the brake torque should be increased by using a worm gear because the rotor should be held in a stationary position when external pressure is applied on the output shaft that rotates forward and reverse.

To use a worm gear and a worm wheel in a DC motor and to deliver power to the position where the output shaft is located, the connection therebetween is usually formed using a spur gear, in which case the following problems exist.

First, since the housing height of the actuator is low, there is a problem in that a DC motor is generally laid and applied, and thus an assembly structure is difficult and a unit cost is increased. That is, there is a problem in securing an assembly space due to the casing of the DC motor and the bearing that needs to hold the worm shaft.

Second, the structure of connecting the motor power to a motor controller becomes complicated.

Third, rotational position information of the rotor is required for accurate position control in the actuator. To this end, since a rotational position sensing magnet is arranged at the bottom of a warm gear of a DC motor and a rotational position sensing Hall sensor integrated circuit (IC) is applied, the structure of connecting a Hall sensor to a PCB is complicated to use DC power and to sense the rotational position.

Fourth, in a gear train that uses multiple spur gears to obtain a large reduction ratio, the tolerance the rotating power of the driving motor increases, resulting in a large backlash and difficulty in controlling the precise position.

Meanwhile, in recent years, a swivel actuator has been used to rotate a main body of a driven object (i.e., a car seat) from side to side along with a rotary table as an actuator for rotating a vehicle car seat from side to side.

Considering that conventional actuators use direct-current (DC) motors lying inside low-height housing, a swivel actuator with a compact and slim structure, by installing a core motor-type brushless direct-current (BLDC) motor vertically on the bottom of the housing and installing a reduction gear train on the top thereof is proposed in Korean Patent Application Publication No. 10-2022-0056821 (Patent Document 1).

The swivel actuator of Patent Document 1 also proposes a structure of rotating a rotary table by a power transmission structure capable of minimizing backlash, by a gear train change structure of minimizing the number of coupling gears, by integrally forming a worm wheel and a worm gear at intervals on a power transmission shaft.

However, since the swivel actuator of Patent Document 1 is a structure that transmits rotational power using one gear train between the BLDC motor and the pinion gear unit driving the rotary table, the tolerance between gears may be reduced, but not completely reduced, and the brake torque that controls the left and right rotation of the driven object main body (i.e., car seat) that rotates with the rotary table is low, making it impossible to suppress vibration generation.

### DISCLOSURE

### Technical Problem

The present invention has been made in an effort to solve the defects of the conventional technology, and thus it is an objective of the present invention to provide a swivel actuator capable of minimizing backlash and suppressing vibration generation of a rotary table by employing a double worm structure at both ends of a power transmission shaft of a first gear train and a second gear train, thereby coupling four pinion gear units to four worm gears and thus transmitting rotating power high torque converted by deceleration at four points of a ring gear of the rotary table.

It is another objective of the present invention to provide a swivel actuator that can increase the fracture strength by increasing the brake torque while minimizing the backlash by employing a double worm structure at both ends of a first gear train and a second gear train, thereby coupling four pinion gear units to four worm gears and thus driving a rotary table.

It is another object of the present invention to provide a swivel actuator capable of removing tolerance generated when coupling between gears and enabling a backlash to be zero by suppressing left and right displacements in a bearing housing by using a set screw on both ends of a power transmission shaft of first and second gear trains.

### Technical Solution

According to an aspect of the present invention, there is provided a swivel actuator including: a lower housing having a hollow cylindrical portion protruding upward at a center thereof; an upper housing stacked and assembled on an upper portion of the lower housing and having a through hole formed in a central portion thereof in which the hollow cylindrical portion protrudes upward through the through hole; a driving motor arranged on a bottom surface of the lower housing and having a rotor worm gear integrally formed on an outer periphery of a cylindrical rotor support extending upward through a through hole of the upper housing; first and second gear trains, each being arranged at 180 degree intervals at the outer periphery of the rotor worm gear and being coupled thereto, having, in the middle of first and second power transmission shafts, first and second worm wheels gear-coupled to the rotor worm gear, and having first to fourth worm gears formed at both sides of each of the first and second power transmission shafts; first to fourth pinion gear units in which third to sixth worm wheels gear-coupled to the first to fourth worm gears are formed at the lower ends of first to fourth support shafts, respectively, and first to fourth pinion gears are integrally formed on the upper ends of the first to fourth support shafts, respectively; and a rotary table gear-coupled to a ring gear having the first to fourth pinion gears integrally formed on the inner side of the side surface portion thereof, so as to rotate.

The swivel actuator according to the present invention may further include: first and second bearings arranged between the cup-shaped lower end of the rotor support and a lower end of the hollow cylindrical portion to rotatably support the rotor, and stacked in series; and a third bearing rotatably supporting the rotary table on an outer periphery of a top end of the hollow cylindrical portion.

In addition, the swivel actuator according to the present invention may further include a bearing support press-coupled to the outer periphery of the hollow cylindrical portion and arranged between the second bearing and the third bearing to press the second bearing.

In this case, the upper housing may include first and second concave grooves which are arranged to face each other at intervals of 180 degrees around the through hole, and accommodate the first and second gear trains and the first to fourth pinion gear units.

In addition, the driving motor includes: a rotor having a rotor support having a cup shape at a lower end thereof, and rotatably coupled to an outer periphery of the hollow cylindrical portion; a stator which is arranged on the outer side of the rotor with an air gap, generates a rotating magnetic field, and is arranged on the bottom of the housing to rotate the rotor; first and second bearings arranged between the cup-shaped lower end of the rotor support and a lower end of the hollow cylindrical portion to rotatably support the rotor, and stacked in series; and a bearing support press-coupled to the outer periphery of the hollow cylindrical portion to press the second bearing.

In this case, the rotor support may include: an inner concave groove provided inside the lower end thereof to serve as a bearing housing for accommodating the first and second bearings; and an outer concave groove formed outside the lower end thereof to serve as a support for accommodating a back yoke and a magnet of the rotor, wherein each of the first and second bearings may be configured as a ball bearing in which an inner race is supported by the hollow cylindrical portion and an outer race is supported in the inner concave groove.

In addition, the inner race of each of the first and second bearings may have a lower end supported by a stepped portion catching protrusion formed on the outer periphery of the hollow cylindrical portion by press-fitting the bearing support to the hollow cylindrical portion, and the outer race of each of the first and second bearings may be supported by the inner concave groove provided inside the lower end portion of the rotor support.

The swivel actuator according to the present invention may further include a rotor worm gear separation prevention protrusion protruding from the top end of the bearing support to prevent the rotor from separating from the first and second bearings and making contact with the third bearing.

In this case, the rotor worm gear is positioned vertically in the center of the through hole, the first and second power transmission shafts are positioned in a horizontal direction which is perpendicular to a rotor worm gear shaft in the first and second concave grooves arranged to face each other around the through hole of the upper housing at 180 degrees intervals, and the first to fourth support shafts may be positioned vertically in the first and second concave grooves of the upper housing.

In addition, both ends of each of the first and second power transmission shafts are rotatably supported by bearings, and a plurality of set screws may be installed in the bearing housing in which the bearings are embedded to suppress the occurrence of left and right displacements of the first and second power transmission shafts.

The swivel actuator according to the present invention may further include: a pair of bearings rotatably supporting both ends of each of the first and second power transmission shafts, respectively; a pair of bearing housings, which are respectively installed in first and second concave grooves arranged to face each other at an interval of 180 degrees around the through-hole of the upper housing, to accommodate and support the pair of bearings therein; and a pair of set screws coupled to the rear ends of the pair of bearing housings, respectively, such that the front ends thereof press and support the ends of the first and second power transmission shafts.

In this case, the swivel actuator according to the present invention may further include through holes for adjusting the set screws, which are formed on a wall of the upper housing to advance the set screws from the outside to push and fix the first and second power transmission shafts to one side.

As a result, the set screws are rotated from the outside to push and fix the first and second power transmission shafts to one side, by using a tool through the through holes for adjusting the set screws, which are formed in the upper housing, thereby suppressing axial displacement of the first and second power transmission shafts.

The swivel actuator according to the present invention may include: a driving motor for generating rotational power through a rotor worm gear integrally formed on an outer periphery of a cylindrical rotor support; first and second gear trains in which first and second worm wheels, which are placed and combined at 180 degrees intervals on the outer periphery of the rotor worm gear for primary reduction, are formed in the middle of the first and second power transmission shafts, respectively, and first to fourth worm gears are formed on both sides of the first and second power transmission shafts, respectively; first to fourth pinion gear units in which third to sixth worm wheels, which are gear-coupled to the first to fourth worm gears for secondary reduction, are rotatably coupled to the lower ends of the first to fourth support shafts, respectively, and first to fourth pinion gears, which are engaged with and rotatably coupled to the third to sixth worm wheels, are rotatably coupled to the upper ends of the first to fourth support shafts, respectively; and a rotary table in which a ring gear, which is gear-coupled to the first to fourth pinion gears for tertiary reduction, is integrally formed inside the side surface portion, wherein the rotary table is used to rotatably drive a car seat.

The swivel actuator according to the present invention may further include: a lower housing in which a hollow cylindrical portion, which rotatably supports the cylindrical rotor support and the rotary table, protrudes upward from the center thereof and the driving motor is installed; and an upper housing stacked above the lower housing, having a through hole formed in a central portion thereof, through which the hollow cylindrical portion protrudes upward, and having the first and second gear trains and first to fourth pinion gear units installed therein. A first reduction ratio of the primary reduction, a second reduction ratio of the secondary reduction, and a third reduction ratio of the tertiary reduction may be sequentially set less toward a rear end.

In this case, when the rotor and the first worm gear of the driving motor rotate clockwise, the first and second power transmission shafts may rotate counterclockwise, and the rotary table may rotate clockwise.

In addition, the rotary table includes: an upper plate on which a driven body is installed; a side surface portion extending downward from an outer circumferential portion of the upper plate; and and a ring gear integrally formed inside the side surface portion, wherein the first to fourth pinion gears of the first to fourth pinion gear units may be gear-coupled to the ring gear of the rotary table at four points.

### Advantageous Effects

As described above, in the present invention, a worm wheel and a worm gear are integrally formed at intervals on a power transmission shaft to provide a power transmission structure capable of minimizing backlash by a gear train change structure in which the number of coupling gears is minimized. As a result, the present invention may reduce overall size and secure a space compared to a conventional gear train in which a plurality of spur gears are combined, thereby increasing degree of freedom in design and reducing costs.

In addition, according to the present invention, a BLDC driving motor is installed on the bottom of a housing, and first and second gear trains, in which a worm wheel and a worm gear are integrally formed at intervals on a power transmission shaft, are arranged in a symmetrical structure in the housing, thereby minimizing backlash and simultaneously suppressing vibration generation of the rotary table.

Moreover, in this invention, the BLDC driving motor is installed on the bottom of the housing, the worm wheels of the first and second gear trains are arranged in a symmetrical structure on the outer periphery of the cylindrical rotor worm gear of the driving motor, and four pinion gear units are combined with the four worm gears formed at both ends of the first and second gear trains to transmit the rotational force, which is high torque converted by reduction, to the ring gear of the rotary table at four points, thereby minimizing backlash and suppressing the vibration generation of the rotary table.

In addition, the swivel actuator according to the present invention may employ a double worm structure at both ends of each of a first gear train and a second gear train, thereby coupling four pinion gear units to four worm gears and thus driving a rotary table, to accordingly increase the fracture strength by increasing the brake torque while minimizing the backlash.

In general, the swivel actuator is rotatably supported on a fixed frame fixed to a floor panel inside a vehicle, and a car seat is installed on the rotary table installed and rotating on top of the swivel actuator.

In this case, the swivel actuator is driven in an electric manner so that the rotary table may be rotated in a desired direction for the fixed frame according to a user's manipulation of an operation switch. The swivel actuator may be driven in a manner of rotating by a preset angle in conjunction with a manipulation (turn-on) of the operation switch or stopping at a position the rotated swivel actuator when a manipulation of the operation switch is stopped (turn-off) while rotating in conjunction with the manipulation (turn-on) of the operation switch.

When a user drives the swivel actuator in an electric manner to rotate by a desired rotation angle and then stop, it is required to have a predetermined brake torque between the output of the driving motor, that is, the rotor worm gear and the rotary table, according to the manipulation (turn-on) of the operation switch.

Since the rotary table being rotationally driven has rotational inertia, it is necessary to increase the brake torque determined by a power transmission mechanism of the gear train and the pinion gear unit, which are coupled between the rotor worm gear and the ring gear of the rotary table to stop at a desired position.

In the rotary table in which the car seat on which a user is seated is installed, the number of engagement gears between the ring gear and the pinion gear arranged at the outer side of the rotary table is small, and thus a large force is not transferred. In this case, since the pinion gear, which is a spur gear, has a smaller gear diameter than the ring gear, the number of engagement gears between the ring gear and the pinion gear is about 1 each to about 1.5 each per pinion gear.

Therefore, in order to increase the brake torque between the ring gear and the pinion gear, it is desirable to increase the number of engagement gears (the number of gear teeth in contact) as many as possible.

In this case, as the swivel actuator according to the present invention adopts a double worm structure at both ends of each of the first and second gear trains, four pinion gear units are combined with four worm gears and power is transmitted to the ring gear of the rotary table at four points, thereby increasing the number of engagement gears (the number of engaged gear teeth) and driving the rotary table, and thus increasing the break torque and increasing the fracture strength.

As described above, when the brake torque increases, the degree of freedom for selecting the material of the gear is increased. Accordingly, although a steel-use-stainless (SUS)-processed product is used as a gear material in the related art, it is currently possible to use a product made of a sintered metal or a plastic-processed product, and thus it is preferable to have a better competitiveness in terms of a price side and a productivity side, and thus it is preferable to increase the number of engagement gears when engaged with each other.

In addition, when the first and second gear trains are arranged in a symmetrical structure on the outer periphery of the cylindrical rotor worm gear inside the upper housing as described above, it is possible to reduce the tolerance between the gears, but it is difficult to completely reduce the tolerance. In other words, the gap between the gears is minimized, but the tolerance between the gears occurs, resulting in a gap between the gears, which may cause the rotary table gear-coupled with the pinion gear unit to shake left and right.

This problem may be caused by the occurrence of the left and right (i.e., axial) displacement of both ends of the power transmission shafts forming the gear train in the bearing housing. Accordingly, in the present invention, a set screw screw-coupled to a set screw assembly unit formed to extend to the rear end of the bearing housing is added to suppress occurrence of left and right displacement of both ends of the power transmission shafts in the bearing housing, and axial displacement of the first and second power transmission shafts may be suppressed by pushing and fixing the first and second power transmission shafts to one side by tightening the set screw from the outside through set screw adjustment through-holes formed in the housing.

As a result, by suppressing the left and right displacement of the first and second power transmission shafts, the tolerance (gap) that occurs when the gears are coupled between the worm gear of the gear train and the worm wheel of the pinion gear unit is eliminated, and as a result, the gap between the pinion gear of the pinion gear unit and the ring gear of the rotary table may be removed to zero the backlash.

### BRIEF DESCRIPTION OF THE DRAWINGS

FIGS. 1 to 3A are a perspective view, a plan view, and a cross-sectional view taken along line A-A of FIG. 2, respectively, of a hollow swivel actuator according to a preferred embodiment of the present invention.

FIG. 3B is a half (½) enlarged view of an axial cross section of a hollow swivel actuator according to a preferred embodiment of the present invention.

FIGS. 4 and 5 are an exploded perspective view illustrating that a rotary table is separated from a hollow swivel actuator according to a preferred embodiment of the present invention, and a plan view of FIG. 4 in which the rotary table has been removed, respectively.

FIGS. 6A to 6C are cross-sectional views taken along line B-B, line C-C, and line D-D of FIG. 5, respectively.

FIGS. 7 and 8 are a module—each exploded perspective view and a fully exploded perspective view of a hollow swivel actuator according to a preferred embodiment of the present invention, respectively.

FIG. 9 is an exploded perspective view illustrating an upper portion of a rotary table has been removed from a hollow swivel actuator according to a preferred embodiment of the present invention.

### BEST MODE FOR CARRYING OUT THE INVENTION

Hereinafter, embodiments of the present invention will be described in detail with reference to the accompanying drawings.

The sizes and shapes of the components shown in the drawings may be exaggerated for clarity and convenience. In addition, terms defined in consideration of the configuration and operation of the present invention may vary depending on the intention or custom of the user, the operator, and the like. Definitions of these terms should be based on the content of this specification.

A swivel actuator according to the present invention is used, together with a rotary table, to rotate a driven body, that is, a vehicle car seat, left and right. When a swivel actuator is installed in a lower plate fixed to a bottom surface of a vehicle and a connection frame installed in a rotary table is fixed to an upper plate in which a car seat is installed, the car seat may also be rotated according to the rotation of the rotary table.

In the following description, a hollow swivel actuator that drives a driven body using a BLDC-type driving motor as a power source is described.

It is difficult to apply a BLDC motor to a general motor, but in this invention, the BLDC motor is vertically erected and the size of the BLDC motor in a radial direction is increased to increase motor torque. The driving motor has a stator and a rotor arranged on the bottom surface of the housing, and uses an inner rotor type BLDC motor.

An actuator according to the conventional art includes a motor portion made of a DC motor, a gear part, and a rotating part, which are configured as separate components, so when assembling the actuator to a main body using an actuator product, there are many problems such as assembly tolerance and supply of parts.

A swivel actuator according to the present invention includes a driving motor, a gear train, and a rotating body, which are integrally formed, to thereby achieve miniaturization and slimness while solving the problems of conventional technology.

In addition, a hollow swivel actuator according to the present invention is formed in a disc shape, and includes a through-hole for withdrawing a cable, which is formed in a central portion thereof as an inner hollow shape, and a plurality of coupling holes, for example, four coupling holes, which are formed on an upper portion of a rotating body (a rotary table) so as to be connected to a passive object, in which a lower end portion of a fixing bolt passes through each of the coupling holes so as to be screw-coupled to and fixed to a stud nut fixedly installed on an inner surface of the rotary table.

Moreover, the hollow swivel actuator according to this invention may minimize backlash and suppress vibration generation by installing a BLDC-type driving motor on the bottom of a housing and placing, in a symmetrical structure inside the housing, first and second gear trains in which a worm wheel and worm gear are integrally formed at intervals on a power transmission shaft.

The swivel actuator has an annular stator arranged on the bottom of the housing and a rotor arranged therein and having a rotor worm gear integrally formed on the upper side thereof. The pair of gear trains are coupled to the outer periphery of the rotor worm gear in a symmetrical structure. The worm wheel of the power transmission shaft forming each gear train is gear-coupled to the outer periphery of the rotor worm gear. The four worm gears formed at both ends of the power transmission shaft are coupled to the worm wheels located at the bottom of each of the four pinion gear units. The four pinion gears located at the top of the four pinion gear units are coupled at four points to the ring gear formed inside the side surface portion of the rotary table. Accordingly, the rotary table is rotated and driven with low-speed, high-torque converted rotational force.

As a result, the swivel actuator according to the present invention increases the torque by decelerating the high speed and low torque rotational output of the driving motor, and transmits the rotational force converted to low speed and high torque by reduction to the rotary table. In this case, a pair of gear trains are coupled in a symmetrical structure to a rotor worm gear of a driving motor, a double worm structure is formed at both ends of the pair of gear trains, and power is transmitted to the ring gear of the rotary table through the four pinion gear units on the double worm by increasing the number of engagement gears (the number of contacting teeth). accordingly, it is possible to minimize the backlash, suppress the vibration generation of the rotary table, and increase the brake torque to increase the fracture strength.

The swivel actuator according to the present invention includes a BLDC-based driving motor, a pair of gear trains which increases the torque by deceleration of the rotational power of the driving motor and then transmits the increased torque to the rotary table, four pinion gear units coupled to both ends of each of the pair of gear trains, and a rotary table coupled at four points by an output of the four pinion gear units to rotate together with the ring gear, wherein a driven body is coupled to the rotary table to rotate together with the rotary table.

In this case, the driving motor, the gear trains, the pinion gear units, and the rotary table are integrally assembled to the housing.

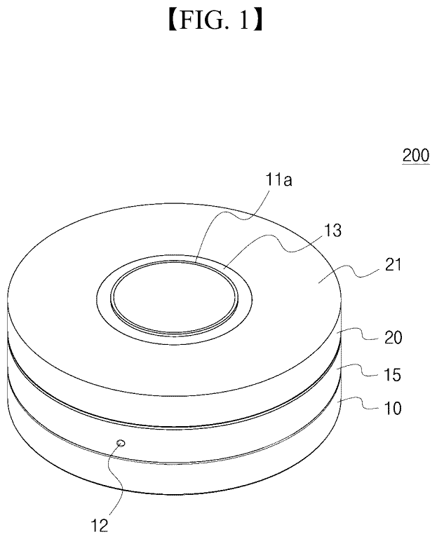

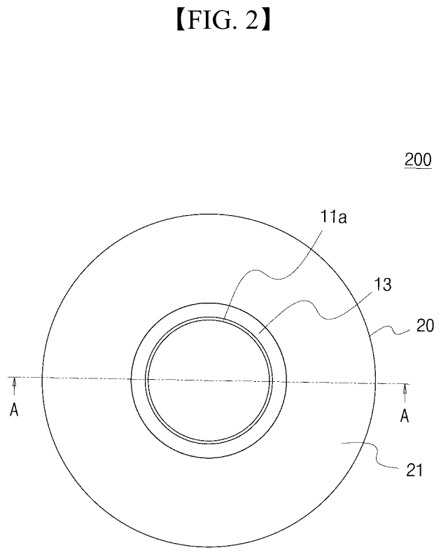

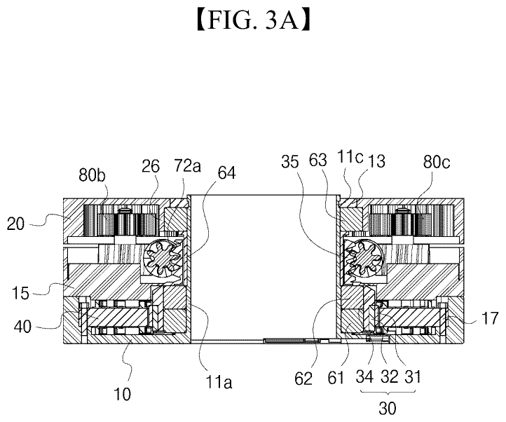

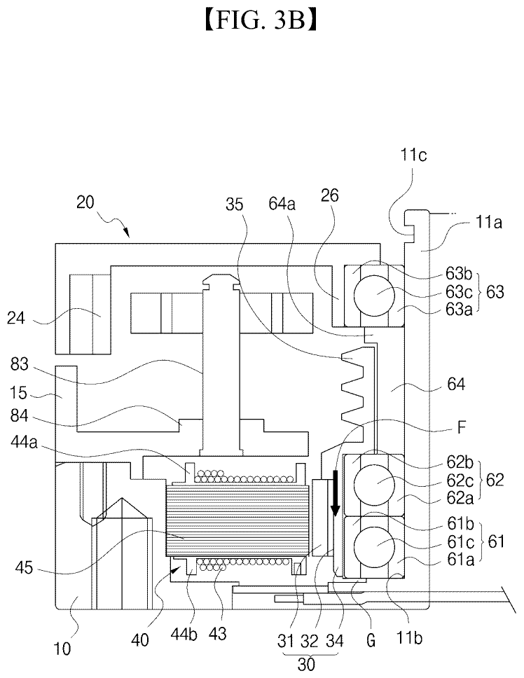

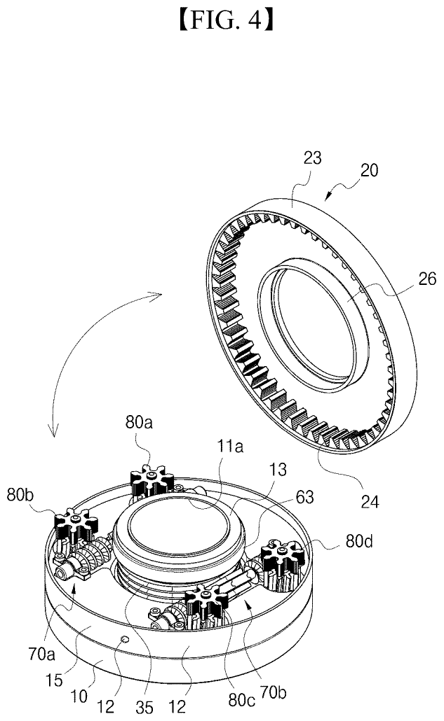

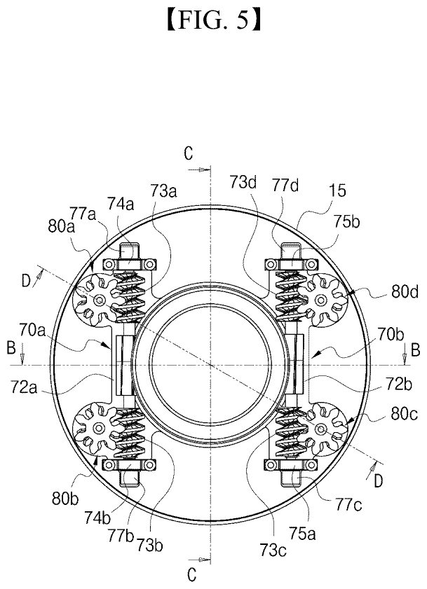

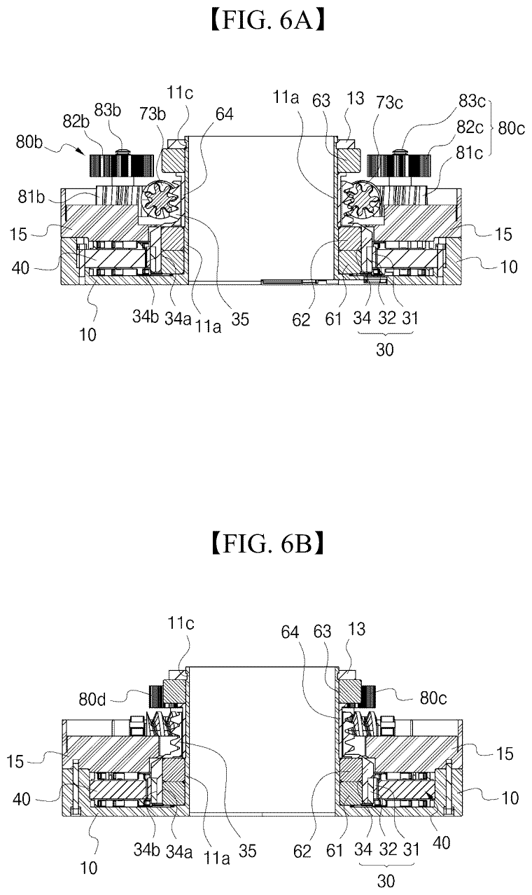

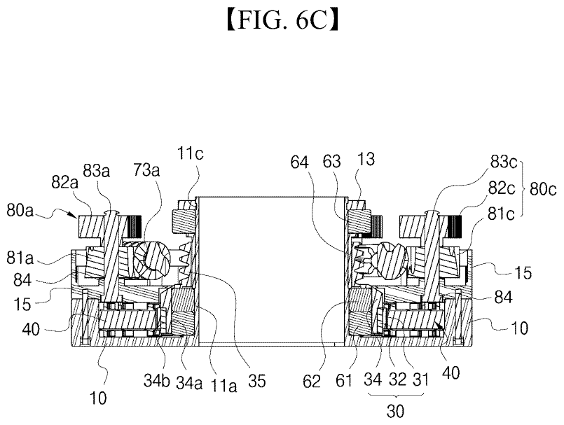

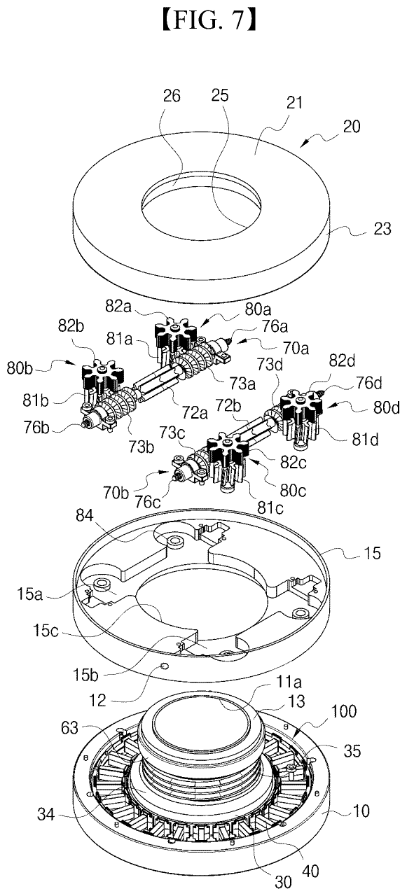

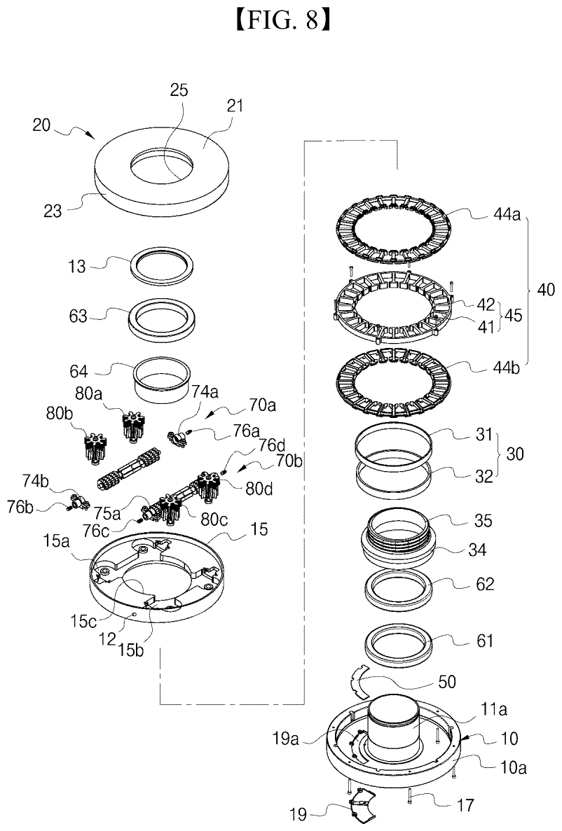

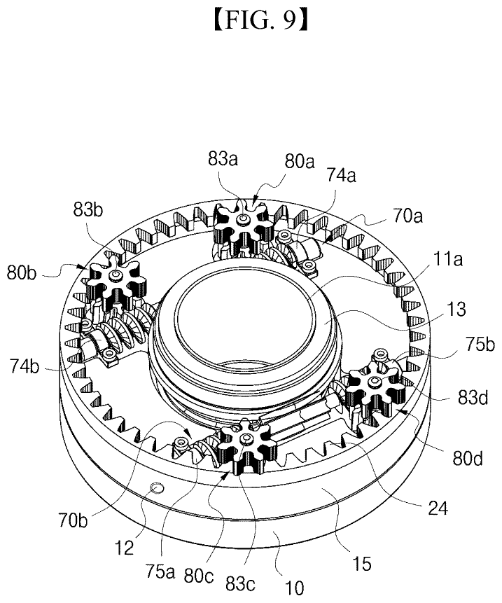

Referring to FIGS. 1 to 9, a hollow swivel actuator 200 according to a preferred embodiment of the present invention includes: a lower housing 10 having a hollow cylindrical portion 11a protruding upward at a center thereof; an upper housing 15 stacked and assembled on an upper portion of the lower housing 10 and having a through hole 15c formed in a central portion thereof in which the hollow cylindrical portion 11a protrudes upward through the through hole 15c; a driving motor 100 which is arranged on a bottom surface of the lower housing 10 and has a first worm gear 35 integrally formed on an outer periphery of an extension unit of a rotor support 34 extending to an upper portion of the rotor 30; first and second gear trains 70a to 70c which are arranged on the upper housing 15, and coupled to the outer periphery of the rotor worm gear 35 in which first and second worm wheels 72a and 72b gear-coupled to the rotor worm gear 35 are respectively formed at the middle portions of first and second power transmission shafts 71a and 71b, and first to fourth worm gears 73a to 73d are respectively formed at one side and the other-side portion of the first and second power transmission shafts 71a and 71b; first to fourth pinion gear units 80a to 80d in which third to sixth worm wheels 81a to 81d gear-coupled to the first to fourth worm gears 73a to 73d are formed at the lower ends of first to fourth pinion gear units 80a to 80d, respectively, and first to fourth pinion gears 82a to 82d are integrally formed on the upper ends of the first to fourth pinion gear units 80a to 80d, respectively; and a rotary table 20 configured to rotate in which the first to fourth pinion gears 82a to 82d of the first to fourth pinion gear units 80a to 80d are gear-coupled to a ring gear 24 integrally formed on the inner side of a side surface portion of the rotary table 20.

The lower housing 10 has a hollow cylindrical portion 11a protruding from the center thereof, and a driving motor 100 is installed in a space between the hollow cylindrical portion 11a and a circular wall 10a.

In addition, the upper housing 15 is stacked and assembled on the upper portion of the lower housing 10, and a plurality of fixing bolts or screws 17 are fastened and fixed between the upper housing 15 and the lower housing 10. The first and second gear trains 70a and 70b and the first to fourth pinion gear units 80a to 80d are accommodated in the upper housing 15, and a rotary table 20 is rotatably installed above the upper housing 15.

For example, the driving motor 100 generates relatively high-speed rotational power, and the first and second gear trains 70a and 70b receive the high-speed rotational power and convert torque by decelerating the rotational speed to generate decelerated rotational power with increased torque.

Additionally, the first to fourth pinion gears 82a to 82d are installed vertically on the first to fourth worm gears 73a to 73d of the first and second gear trains 70a to 70b, respectively, to receive decelerated rotational power with increased torque, and then transmit the same at four point to the ring gear 24 integrated with the rotary table 20, to thereby rotate the rotary table 20 at low speed.

The driving motor 100 may be configured as an inner rotor type in which a rotor is arranged inside a stator, and includes the rotor 30 rotatably coupled to the outer periphery of the hollow cylindrical portion 11a of the lower housing 10, and the stator 40 arranged at an outer side of the rotor 30 with an air gap therebetween and arranged on a bottom surface of the lower housing 10 to rotate the rotor 30 by generating a rotating magnetic field, wherein the rotor worm gear 35 is integrally formed on the outer peripheral portion of the extension portion of the rotor support 34 extending to the upper portion of the rotor 30.

In the rotor 30, a magnet 31 arranged on the outer periphery of a back yoke 32 located inside the rotor 30, may include a magnet which includes split magnet pieces of a plurality of N-poles and S-poles or a magnet in which N-poles and S-poles are split-magnetized in multiple poles in a ring-shaped magnet. The back yoke 32 is installed on a rear surface of the magnet 31 to form a magnetic circuit.

The rotor 30 includes a rotor support 34 having a cup-shaped lower end, and the rotor support 34 includes an inner concave groove 34a provided inside the lower end to serve as a bearing housing for the first and second bearings 61 and 62, and an outer concave groove 34b formed outside the lower end to serve as a support for the back yoke 32 and the magnet 31 of the rotor.

In this case, the rotor support 34 serves as a bearing housing in which the inner concave groove 34a provided inside the lower end thereof accommodates the first and second bearings 61 and 62, and the outer concave groove 34b formed outside the rotor support 34 serves as a support for accommodating the back yoke 32 and the magnet 31.

Furthermore, the rotor support 34 includes a cup-shaped lower end supporting the first and second bearings 61 and 62, the back yoke 32, and the magnet 31 inside and outside, and an upper end extending upward from the lower end through the through hole 15c of the upper housing 15, and a rotor worm gear 35 is integrally formed on the cylindrical outer periphery of the upper end.

As a result, the rotational output of the driving motor 100 is generated from the rotor worm gear 35 integrally formed on the upper portion of the rotor support 34. In this case, the rotor worm gear 35 may be integrally formed at an upper end of the rotor support 34 to be manufactured by an injection molding method.

The first and second bearings 61 and 62 which rotatably support the rotor 30 to the hollow cylindrical portion 11a are installed between the rotor support 34 of the rotor 30 and the hollow cylindrical portion 11a of the lower housing 10.

The first and second bearings 61 and 62 are stacked up and down in series between the rotor support 34 and the hollow cylindrical portion 11a and stably support the rotor 30.

When stacking a plurality of bearings, it is common to maintain a gap between bearings because there is a gap between adjacent bearings. However, according to the present invention, the first and second bearings 61 and 62 stacked in series without a gap between the bearings support the rotor 30 in a large area, thereby promoting verticality and dimensional stability when the rotor 30 rotates.

The first and second bearings 61 and 62 may be configured as ball bearings in which balls 61c and 62c are inserted between inner races 61a and 62a and outer races 61b and 62b, respectively.

The lower ends of the inner races 61a and 62a of the first and second bearings 61 and 62 are supported by a stepped portion catching protrusion 11b formed on the outer periphery of the hollow cylindrical part 11a, and the outer races 61b and 62b of the first and second bearings 61 and 62 are supported by an inner concave groove 34a provided inside the lower end of the rotor support 34.

In addition, the inner races 61a and 62a of the first and second bearings 61 and 62 may be supported and fixed to the stepped portion catching protrusion 11b by press-fitting the bearing support 64 to the hollow cylindrical portion 11a.

Further, a rotor worm gear separation preventing protrusion 64a is protruded from the upper end of the bearing support 64 to prevent the rotor worm gear 35 formed on the extension portion of the rotor support 34 from being separated.

The rotor worm gear 35 rotates in a radial direction in a clockwise (CW) or counterclockwise (CCW) direction, but receives a force up and down.

In the rotor worm gear 35, the rotor 30 may be separated from the first and second bearings 61 and 62 by an up-and-down force to make a touch with the third bearing 63. In order to prevent such a touch from occurring, it is preferable that the bearing support 64 be provided with a rotor worm gear separation prevention protrusion 64a.

The stator 40 includes: a stator core 45 having a plurality of teeth 41 each having a “T” shape and a back yoke 42 interconnected with the plurality of teeth 41 to form a magnetic circuit; upper and lower insulators 44a and 44b made of insulating material, which are integrally formed to surround the outer circumferential surface on which coils 43 of each of the plurality of teeth are wound; and the coil 43 wound around the outer circumferential surfaces of the insulators 44a and 44b.

In this case, the insulator 44a and 44b may be integrally formed as a bobbin and a stator support surrounding the back yoke 42 along with the plurality of teeth 41.

The swivel actuator 200 according to this invention may include the BLDC motor with a 20 pole-18 slot structure, for example, as the driving motor 100. In addition, when the coil 43 of the stator 40 is wound on the plurality of teeth 41, the driving motor 100 may be configured to wind the coil 43 in a U, V, and W three-phase structure, and the other ends of the U, V, and W three-phase coils 43 may be connected in a Y-connection or star-connection manner.

Furthermore, the driving motor 100 may be driven by a 6-step full-wave driving method using an inverter after receiving a rotor position signal from two or three Hall sensors H1 to H3 mounted on a Hall sensor assembly 50 in a motor driving circuit.

The first and second gear trains 70a and 70b are respectively arranged in the first and second concave grooves 16a and 16b formed on the bottom 15b in a structure opposite to each other, centering on the hollow cylindrical portion 11a of the lower housing protruding upward through the through hole 15c located at the center of the upper housing 15.

The first and second gear trains 70a and 70b include first and second power transmission shafts 71a and 71b arranged to face each other at intervals of 180 degrees on the outer periphery of the rotor worm gear 35, first and second worm wheels 72a and 72b that are gear-coupled to the rotor worm gear 35 in the middle of the first and second power transmission shafts 71a and 71b, and first to fourth worm gears 73a to 73d formed on one-side portions and the other-side portions of the first and second power transmission shafts 71a and 71b, respectively.

Both ends of each of the first and second power transmission shafts 71a and 71b are rotatably supported by a pair of bearings 74a and 74b and a pair of bearings 75a and 75b, respectively, and the first and second concave grooves 16a and 16b have a concave groove shape that accommodates the first and second gear trains 70a and 70b and the first to fourth pinion gear units 80a to 80d.

The first and second gear trains 70a and 70b achieve primary reduction as the first and second worm wheels 72a and 72b provided in the middle portions of the first and second power transmission shafts 71a and 71b are coupled to the outer periphery of the rotor worm gear 35 at 180 degrees intervals to transmit rotational power.

In this case, in the present invention, set screws 76a to 76d are added to the rear ends of the bearing housings 77a to 77d, respectively, to prevent the first and second power transmission shafts 71a and 71b from causing left and right displacements in the bearing housings 77a to 77d supporting two pairs of bearings 74a, 74b, 75a and 75b to limit the left and right displacements of the first and second power transmission shafts 71a and 71b.

The set screws 76a to 76d each include: a male screw formed on an outer periphery of a body; and a concave groove of a “−” or “+” shape capable of accommodating a front end of a driver which is formed at a rear end thereof, wherein the front end is curved or flat.

Each of the set screws 76a to 76d is screw-coupled to a female thread formed in a through hole penetrating inward from the rear end of each of the bearing housings 77a to 77d, and the front ends of the six set screws 76a to 76d are coupled in a manner of pushing and compressing both ends of each of the first and second power transmission shafts 71a and 71b.

The set screws 76a to 76d may be preferably installed in all four bearing housings 77a to 77d of the four bearings 74a, 74b, 75a, and 75b that rotatably support both ends of the first and second power transmission shafts 71a and 71b, or the set screws 76a to 76d may be installed only in one-side portions of the bearing housings 77a to 77d to support one-end portions of the first and second power transmission shafts 71a and 71b to push the first and second power transmission shafts 71a and 71b in one direction to suppress the left and right displacements thereof.

The set screws 76a to 76d may have front end portions protruding in a spherical shape to minimize contact with the ends of the first and second power transmission shafts 71a and 71b. Alternatively, it is also possible to use the set screws 76a to 76d having front end portions in a surface shape. In this invention, since the round per minute (rpm) of the driving motor 100 is few and the gear ratio thereof is large, the shapes of the front end portions of the set screws 76a to 76d are not significantly influential.

The first to four pinion gear units 80a to 80d are installed in the first to fourth support shafts 83a to 83d having lower ends installed through the concave grooves 16a and 16b of the upper housing 15, the third to sixth worm wheels 81a to 81d gear-coupled to the first to fourth worm gears 73a to 73s are rotatably coupled to lower ends of the first to fourth support shafts 83a to 83d, respectively, and the first to fourth pinion gears 82a to 82d are integrally formed with the third to sixth worm wheels 81a to 81d on upper ends of the first to fourth support shafts 83a to 83d, respectively.

When the third to sixth worm wheels 81a to 81d are rotatably supported at the lower ends of the first to fourth support shafts 83a to 83d, a protrusion 84 for preventing friction is protruded from the portion where the first to fourth support shafts 83a to 83d are installed to minimize contact friction with the bottom surface of the upper housing 15.

The third to sixth worm wheels 81a to 81d and the first to fourth pinion gears 82a to 82d may be integrally formed by injection molding using synthetic resin, and may be manufactured separately, assembled with each other, and rotatably coupled to the first to fourth support shafts 83a to 83d, respectively.

The rotary table 20 has the circular upper plate 21 and the side surface portion 23 extending downward from the outer periphery of the upper plate 21. The upper plate 21 has a plurality of coupling holes which are penetratively formed for coupling with a main body, which is a passive body (e. g., electric seat) installed in the rotary table 20.

A central through hole 25 through which a cable for connecting to a motor driving circuit installed outside the swivel actuator 200 passes from a stator coil 43 of the driving motor 100 and a plurality of Hall sensors provided in the Hall sensor assembly 50 is formed at the center of the upper plate 21.

Accordingly, the cable is introduced downward through the central through hole 25 provided in the center of the upper plate and the hollow cylindrical portion 11a of the lower housing 10, and then connected to a stator coil 43 and a Hall sensor assembly 50 through a through hole 19a formed at the bottom of the lower housing 10. The through hole 19a is finished by being assembled with a through hole cover 19.

In this case, a printed circuit board (PCB) on which a motor driving circuit is implemented may be installed outside the swivel actuator 200 and then connected to the stator coil 43 and the Hall sensor assembly 50 of the driving motor 100 installed inside through the cable. However, the printed circuit board (PCB) in which the motor driving circuit is implemented may be embedded in a space formed under the lower housing 10 or under the upper housing 15.

When connected to the stator coil 43 and the Hall sensor assembly 50 of the driving motor 100 installed from the outside through the cable, the cable needs to include eight wires consisting of U, V, and W output terminals of the inverter circuit, three Hall sensors H1 to H3, Vcc, and GND.

Moreover, the upper end of the hollow cylindrical portion 11a of the lower housing 10 is located in the central through hole 25, and a third bearing 63 may be installed in the center of the inner circumferential surface of the upper plate 21 to rotatably support the rotary table 20 to the outer periphery of the hollow cylindrical portion 11a.

The third bearing 63 may be configured as a ball bearing in which a ball 63c is inserted between an inner race 63a and an outer race 63b. In this case, the outer race 63b of the third bearing 63 is supported by the bearing housing 26 protruding from the lower portion of the rotary table 20, and the inner race 63a of the third bearing 63 is supported by the hollow cylindrical portion 11a of the lower housing 10 while the lower end thereof is supported by the upper end of the bearing support 64.

Furthermore, the hollow swivel actuator 200 has a stopper insertion concave groove 11c formed at the upper end of the hollow cylindrical portion 11a, and a stopper 13 is coupled to the stopper insertion concave groove 11c to prevent the rotary table 20 from being separated.

A ring gear 24 is integrally formed inside the side surface portion 23 of the rotary table 20, and first to fourth pinion gears 82a to 82d of the first to fourth pinion gear units 80a to 80d are gear-coupled to the ring gear 24.

As described above, the present invention provides a power transmission structure capable of minimizing backlash due to a gear train change structure that minimizes the number of coupled gears, by arranging the first and second worm wheels 72a and 72b in each of the first and second power transmission shafts 71a and 71b, and forming the first to fourth worm gears 73a to 73d in an integral form at intervals in each of the first and second power transmission shafts 71a and 71b.

As a result, the present invention may reduce overall size and secure a space compared to a conventional gear train in which a plurality of spur gears are combined, thereby increasing degree of freedom in design and reducing costs.

In addition, in the present invention, the BLDC driving motor 100 is installed on the bottom of the lower housing 10, and the first and second gear trains 70a and 70b are arranged inside the upper housing 15 assembled above the lower housing 10 to face each other at an interval of 180 degrees, to minimize backlash and suppress vibration generation. Here, the first and second gear trains 70a and 70b are configured so that the first and second worm wheels 72a and 72b and the first to fourth worm gears 73a to 73d are integrally formed at intervals with the first and second power transmission shafts 71a and 71b.

In this invention, as described above, the first to fourth worm gears 73a to 73d are integrally formed to have a double worm structure at both ends of each of the first and second power transmission shafts 71a and 71b while evenly arranging and combining the two first and second gear trains 70a and 70b at 180 degrees intervals to the rotor worm gear 35 of the driving motor 100, and the first to fourth worm gears 73a to 73d are gear-coupled at four points in the ring gear 24 using the four third to sixth worm wheels 81a to 81d of the first to fourth pinion gear units 80a to 80d and the first to fourth pinion gears 82a to 82d thereof.

As a result, in the present invention, as a double worm structure is adopted at either end of each of the first and second gear trains 70a and 70b, the four pinion gear units 80a to 80d are combined with the four worm gears 73a to 73d to drive the rotary table 20, thereby increasing the fracture strength while increasing the brake torque while minimizing the backlash.

As described above, when the first and second gear trains 70a and 70b are arranged inside the upper housing 15, it is possible to reduce a tolerance between gears, but it is difficult to completely reduce the tolerance. That is, a gap between the gears is minimized but a tolerance between gears is generated to form a gap, and thus the rotary table 20 gear-coupled to the first to fourth pinion gears 82a to 82d and the passive object to be driven thereon may be shaken in the left and right directions.

This problem may be caused by the occurrence of the left and right displacement of both ends of the power transmission shafts forming the gear train in the bearing housing. In this invention, both ends of each of the first and second power transmission shafts 71a and 71b are rotatably supported by four bearings 74a, 74b, 75a and 75b, respectively.

The four bearings 74a, 74b, 75a, and 75b are embedded in the four bearing housings 77a to 77d fixedly installed in the first and second concave grooves 16a and 16b formed on the bottom of the upper housing 15. In this invention, four set screws 76a to 76d are added to the rear ends of the bearing housings 77a to 77d so that both ends of each of the first and second power transmission shafts 71a and 71b suppress the occurrence of left and right displacements in the bearing housings 77a to 77d.

As a result, the left and right displacements of the first and second power transmission shafts 71a and 71b are suppressed to eliminate a tolerance (gap) generated when the first to fourth worm gears 73a and 73d of the first and second gear trains 70a and 70b and the third to sixth worm wheels 81a to 81d of the first to fourth pinion gear units 80a to 80d are gear-coupled with each other. In addition, the gap between the first to fourth pinion gears 82a to 82d of the first to fourth pinion gear units 80a to 80d and the ring gear 24 of the rotary table 20 may be removed to zero the backlash.

The compression between the set screws 76a to 76d and the first and second power transmission shafts 71a and 71b may push the first and second power transmission shafts 71a and 71b to suppress the left and right movement of the first and second power transmission shafts 71a and 71b, by advancing the set screws 76a to 76d in one direction from the outside through the set screw adjustment through hole 12 formed in the wall 15a of the upper housing 15, after the first and second power transmission shafts 71a and 71b have been assembled inside the upper housing 15.

Hereinafter, an operation of the hollow swivel actuator 200 according to the present invention will be described with reference to FIGS. 1 to 9.

When the BLDC driving motor 100 installed on the bottom of the lower housing 10 is operated in the hollow swivel actuator 200 of this invention, the rotor 30 rotates and the rotor worm gear 35 formed integrally on the upper side of the rotor support 34 of the rotor 30 rotates in the same direction.

When the rotor worm gear 35 rotates, the first and second worm wheels 72a and 72b of the first and second gear trains 70a and 70b, which are arranged at intervals of 180 degrees on the outer periphery of the rotor worm gear 35, rotate, to accomplish primary reduction, and the first and second power transmission shafts 71a and 71b also rotate.

As a result, the first to fourth worm gears 73a to 73d formed on the other-side portions of the first and second power transmission shafts 71a and 71b rotate the third to sixth worm wheels 81a to 81d of the first to fourth pinion gear units 80a to 80d to be gear-coupled to the first to fourth worm gears 73a to 73d, to thus accomplish secondary reduction.

Accordingly, the first to fourth pinion gears 82a to 82d located at the top ends of the first to fourth pinion gear units 80a to 80d are rotated and driven, and the first to fourth pinion gears 82a to 82d are gear-coupled to the ring gear 24 provided on the rotary table 20 at intervals of 90 degrees to rotate the ring gear 24 in the same direction, thereby accomplishing tertiary reduction.

In general, a reduction ratio of a reducer is calculated as (the number of driven gear teeth/the number of driving pinion gear teeth), and in the case of multi-stage gear coupling, a total reduction ratio is calculated as the product of each reduction ratio.

In this case, in the present invention, when a gear ratio (reduction ratio) (R1) between the rotor worm gear 35 of the driving motor 100 and the first and second worm wheels 72a and 72b of the first and second gear trains 70a and 70b is set to 20:1, a gear ratio (reduction ratio) (R2) between the first to fourth worm gears 73a to 73d and the third to sixth worm wheels 81a to 81d is set to 10:1, and a gear ratio (reduction ratio) (R3) between the first to fourth pinion gears 82a to 82d and the ring gear 24 is set to 2:1, a total reduction ratio of 400:1 may be easily realized.

In this case, when the gear ratio (reduction ratio) between the gears may be set to be smaller toward the output (i.e., R1>R2>R3), and even if a large torque conversion is performed at the final end, a stable high torque output may be obtained.

For example, when the BLDC driving motor 100 is rotated at 800 rpm, the swivel actuator 200 of the present invention is reduced to 400:1 when the total reduction ratio is 400:1 by the three-stage reduction, and the rotary table 20 is reduced to a low speed of 2 rpm and the rotation torque is increased 400 times, resulting in a large torque increase.

When the swivel actuator 200 of the present invention is applied to a car seat in a vehicle, it is possible to rotate the car seat by a desired angle when conducting a meeting or the like inside the vehicle to conduct the meeting while the occupant faces each other.

As described above, as the present invention adopts a double worm structure at either end of each of the first and second gear trains 70a and 70b while arranging the first and second gear trains 70a and 70b in a symmetrical structure inside the upper housing 15, four pinion gear units 80a to 80d are coupled to the four worm gears 73a to 73d to drive the rotary table 20, thereby increasing the fracture strength by increasing the break torque while minimizing the backlash.

In addition, in the present invention, the set screws 76a to 76d are added to the set screw assembly units extending from the rear ends of the bearing housings 77a to 77d so that both end portions of each of the first and second power transmission shafts 71a and 71b suppress left and right displacements from occurring in the bearing housings 77a to 77d.

In the present invention, after assembling all the components of the swivel actuator 200 inside the upper housing 15, one for each of the first and second power transmission shafts 71a and 71b, that is, two of the four set screws 76a to 76d installed in a set screw assembly unit are advanced in one direction, from the outside through the set screw adjustment through hole 12 formed in the wall 15a of the upper housing 15, thereby suppressing the left and right movement of the first and second power transmission shafts 71a and 71b by pushing and fixing the first and second power transmission shafts 71a and 71b to one side.

As a result, the left and right displacements of the first and second power transmission shafts 71a and 71b are suppressed by tightening the set screws 76a to 76d, to thereby eradicate a tolerance (gap) which may be generated during gear-coupling between the first to fourth worm gears 73a to 73d of the first and second gear trains 70a and 70b and the third and sixth worm wheels 81a to 81d of the first to fourth pinion gear units 80a to 80d. In addition, the gap between the first to fourth pinion gears 82a to 82d of the first to fourth pinion gear units 80a to 80d and the ring gear 24 of the rotary table 20 may be removed to zero the backlash.

While the present invention has been particularly shown and described with reference to exemplary embodiments thereof, by way of illustration and example only, it is clearly understood that the present invention is not to be construed as limiting the present invention, and various changes and modifications may be made by those skilled in the art within the protective scope of the invention without departing off the spirit of the present invention.

### INDUSTRIAL APPLICABILITY

The swivel actuator according to the present invention may be applied for rotating a passive object such as a car seat installed on a rotary table so as to rotate left and right together with the rotary table.

What is claimed is:

1. A swivel actuator comprising: a lower housing having a hollow cylindrical portion protruding upward at a center thereof;
an upper housing stacked and assembled on an upper portion of the lower housing and having a through hole formed in a central portion thereof in which the hollow cylindrical portion protrudes upward through the through hole;
a driving motor arranged on a bottom surface of the lower housing and having a rotor worm gear integrally formed on an outer periphery of a cylindrical rotor support extending upward through a through hole of the upper housing;
first and second gear trains, each being arranged at 180 degree intervals at the outer periphery of the rotor worm gear and being coupled thereto, having, in the middle of first and second power transmission shafts, first and second worm wheels gear-coupled to the rotor worm gear, and having first to fourth worm gears formed at both sides of each of the first and second power transmission shafts;
first to fourth pinion gear units in which third to sixth worm wheels gear-coupled to the first to fourth worm gears are formed at the lower ends of first to fourth support shafts, respectively, and first to fourth pinion gears are integrally formed on the upper ends of the first to fourth support shafts, respectively; and
a rotary table gear-coupled to a ring gear having the first to fourth pinion gears integrally formed on the inner side of the side surface portion thereof, so as to rotate.

2. The swivel actuator of claim 1, further comprising:
first and second bearings arranged between the cup-shaped lower end of the rotor support and a lower end of the hollow cylindrical portion to rotatably support the rotor, and stacked in series; and
a third bearing rotatably supporting the rotary table on an outer periphery of a top end of the hollow cylindrical portion.

3. The swivel actuator of claim 2, further comprising a bearing support press-coupled to the outer periphery of the hollow cylindrical portion and arranged between the second bearing and the third bearing to press the second bearing.

4. The swivel actuator of claim 1, wherein the upper housing comprises first and second concave grooves which are arranged to face each other at intervals of 180 degrees around the through hole, and accommodate the first and second gear trains and the first to fourth pinion gear units.

5. The swivel actuator of claim 1, wherein the driving motor comprises:
a rotor having a rotor support having a cup shape at a lower end thereof, and rotatably coupled to an outer periphery of the hollow cylindrical portion;
a stator which is arranged on the outer side of the rotor with an air gap, generates a rotating magnetic field, and is arranged on the bottom of the housing to rotate the rotor;
first and second bearings arranged between the cup-shaped lower end of the rotor support and a lower end of the hollow cylindrical portion to rotatably support the rotor, and stacked in series; and
a bearing support press-coupled to the outer periphery of the hollow cylindrical portion to press the second bearing.

6. The swivel actuator of claim 5, wherein the rotor support comprises:
an inner concave groove provided inside the lower end thereof to serve as a bearing housing for accommodating the first and second bearings; and
an outer concave groove formed outside the lower end thereof to serve as a support for accommodating a back yoke and a magnet of the rotor, wherein
each of the first and second bearings is configured as a ball bearing in which an inner race is supported by the hollow cylindrical portion and an outer race is supported in the inner concave groove.

7. The swivel actuator of claim 5, wherein
the inner race of each of the first and second bearings has a lower end supported by a stepped portion catching protrusion formed on the outer periphery of the hollow cylindrical portion by press-fitting the bearing support to the hollow cylindrical portion, and
the outer race of each of the first and second bearings is supported by the inner concave groove provided inside the lower end portion of the rotor support.

8. The swivel actuator of claim 5, further comprising a rotor worm gear separation prevention protrusion protruding from the top end of the bearing support to prevent the rotor from separating from the first and second bearings and making contact with the third bearing.

9. The swivel actuator of claim 1, wherein
the rotor worm gear is arranged vertically in the center of the through hole,
the first and second power transmission shafts are arranged in a horizontal direction perpendicular to a rotor worm gear shaft in the first and second concave grooves arranged to face each other at 180 degree intervals around the through hole of the upper housing, and
the first to fourth support shafts are arranged perpendicular to the first and second concave grooves of the upper housing.

10. The swivel actuator of claim 1, wherein both ends of each of the first and second power transmission shafts are rotatably supported by bearings, and a plurality of set screws are installed in the bearing housing in which the bearings are embedded to suppress the occurrence of left and right displacements of the first and second power transmission shafts.

11. The swivel actuator of claim 1, further comprising:
a pair of bearings rotatably supporting both ends of each of the first and second power transmission shafts, respectively;
a pair of bearing housings, which are respectively installed in first and second concave grooves arranged to face each other at an interval of 180 degrees around the through-hole of the upper housing, to accommodate and support the pair of bearings therein; and
a pair of set screws coupled to the rear ends of the pair of bearing housings, respectively, such that the front ends thereof press and support the ends of the first and second power transmission shafts.

12. The swivel actuator of claim 11, further comprising through holes for adjusting the set screws, which are formed on a wall of the upper housing and used to push and fix the first and second power transmission shafts to one side from the outside.

13. A swivel actuator comprising:
a driving motor for generating rotational power through a rotor worm gear integrally formed on an outer periphery of a cylindrical rotor support;
first and second gear trains in which first and second worm wheels, which are placed and combined at 180 degrees intervals on the outer periphery of the rotor worm gear for primary reduction, are formed in the middle of the first and second power transmission shafts, respectively, and first to fourth worm gears are formed on both sides of the first and second power transmission shafts, respectively;
first to fourth pinion gear units in which third to sixth worm wheels, which are gear-coupled to the first to fourth worm gears for secondary reduction, are rotatably coupled to the lower ends of the first to fourth support shafts, respectively, and first to fourth pinion gears, which are engaged with and rotatably coupled to the third to sixth worm wheels, are rotatably coupled to the upper ends of the first to fourth support shafts, respectively; and
a rotary table in which a ring gear, which is gear-coupled to the first to fourth pinion gears for tertiary reduction, is integrally formed inside the side surface portion, wherein
the rotary table is used for rotating the car seat.

14. The swivel actuator of claim 13, further comprising:
a lower housing in which a hollow cylindrical portion, which rotatably supports the cylindrical rotor support and the rotary table, protrudes upward from the center thereof and the driving motor is installed; and
an upper housing stacked above the lower housing, having a through hole formed in a central portion thereof, through which the hollow cylindrical portion protrudes upward, and having the first and second gear trains and first to fourth pinion gear units installed therein.

15. The swivel actuator of claim 13, wherein a first reduction ratio of the primary reduction, a second reduction ratio of the secondary reduction, and a third reduction ratio of the tertiary reduction are sequentially set less toward a rear end.
